(19) United States
(12) Patent Application Publication
(10) Pub. No.: US 2016/0092650 A1
(43) Pub. Date: Mar. 31, 2016

(54) SYSTEM AND METHOD FOR DETECTING PRESCRIPTION, TRANSCRIPTION AND ADMINISTRATION ERRORS IN DRUG ADMINISTRATION

(71) Applicant: Mohammed ELASHWAH, Auburn, New South Wales (AU)

(72) Inventor: Mohamed ELASHWAH, Auburn (AU)

(21) Appl. No.: 14/787,469

(22) PCT Filed: Jun. 26, 2014
(86) PCT No.: PCT/AU2014/000658

§ 371 Date: Oct. 28, 2015

(30) Foreign Application Priority Data
Jun. 26, 2013 (AU) 2013902350

(51) Int. Cl. G06F 19/00

(52) U.S. Cl. CPC G06F 19/3456; G06F 19/322

(57) ABSTRACT

A method of administration of a drug or drug regime to a potentially unlimited number of drug recipients, the method comprising the steps of; a) providing a prescription for at least one drug in a drug dosing regime to a drug recipient, b) prior to administration of the at least one drug, inputting drug parameters and drug recipient profile particulars for a particular drug recipient into a computer program c) allowing the program to compare the prescription parameters to a set of safety parameters to determine if the parameters fall within predetermined safety limits thereby avoiding over-doses or under-doses of prescribed drug dosages.

### BACKGROUND

The present invention relates to methods of drug dosing and more particularly relates to an integrated or stand alone computer program for reducing/eliminating prescription errors in drug prescription and administration. More specifically, the present invention relates to a system enabling interactive cross checking of drug dosage regimes for individual patients prior to administration of drugs. The present invention also relates to an automated interactive system for detecting prescription dose errors, either in clinics, pharmacies, during hospital rounds or in other places such as at home and institutions like nursing homes.

The present invention further relates to a computer program which enables comparative cross-check between a prescribed drug administration regime and a reference drug regime database based on the profile of a particular patient type taking into consideration parameters such as age, gender and medical condition. The present invention further relates to a method of drug dosing which is more accurate and eliminates prescription and drug dosing errors.

### PRIOR ART

Prescription drugs are commonly used in management of a wide variety of medical conditions. Prescribing, dispensing and administration of drugs to patients take place in clinics, hospitals, nursing homes, and in homes. When doctors prescribe a drug regime for patients, the private or hospital pharmacist fills the prescription and either provides them to the ward that the patient resides in or nursing home or dispenses them direct to the patient. The shear volume of transactions carries with it the risk of errors in the prescription, dispensing and administration, of drugs to the patient.

Methods used in the past were based entirely on manual activity. Current methods used for drug administration to patients using computer systems are prone to error since there is no accurate cross-checking means to ensure that what is prescribed is within allowable ranges. This can be done manually by checking and rechecking but as there is no readily accessible table of allowable dosages, current checking is based on knowledge of the required dosages. Even with the introduction of computerisation of some aspects of drug prescription and administration, there still remains an unacceptable error rate which can lead to over/under doses leading, in extreme cases, to death. The main disadvantage of the existing softwares is that they cannot identify various types of calculation errors without long manual checking which can lead to dose errors and in an extreme case death. There are a number of relevant patents, journal articles, websites, technical literature, or other publications which describe the problem and previous attempts to solve the problem: for example:

Al Khaja, , et al., Pediatric iron preparations for infants in Bahrain: Sonic therapeutic concerns. International Journal of Clinical Pharmacology and Therapeutics, 2010 48(3): p. 200-205.
Bundy, D. G., et al., Pediatric vaccination errors: Application of the “5 Rights” framework to a national error reporting database. Vaccine, 2009. 27(29): p. 3890-3896.
Condren, M., I. J. Studebaker, and B. M. John, Prescribing errors in a pediatric clinic, Clinical Pediatrics, 2010. 49(1): p. 49-53.
Huang, B., et al., A nationwide survey of physician office visits found that inappropriate antibiotic prescriptions were issued for bacterial respiratory tract infections in ambulatory patients. Journal of Clinical Epidemiology, 2005. 58(4); p. 414-20.
Kirk, R. C., et al., Computer calculated dose in pediatric prescribing. Drug Safety, 2005. 28(9): p. 817-824.

Currently there is no satisfactory error checking method which provides efficient error free drug administration. There is a need to address the aforesaid problems in order to increase efficiency of drug administration and to provide an alternative to the known methods and to reduce the time and additional risks occasioned by errors.

### INVENTION

The present invention seeks to ameliorate the aforesaid disadvantages by providing a method of drug dosing which uses a computer program for reducing or eliminating prescription errors in drug dosing. More particularly the present invention provides interactive cross checking of drug regimes for individual patients prior to admission. The present invention also provides an automated interactive system for detecting dosing prescription errors, either in clinics, pharmacies, homes or during hospital rounds.

In one embodiment the system includes a computer program which is capable of checking errors in a dosage of one or a suite of drugs prescribed for a patient. The present invention further relates to a computer program which enables comparative cross-check between a prescribed drug administration regime and a reference drug regime based on the profile of a particular patient for reducing or eliminating prescription errors in drug dosing.

The present invention further provides a method of drug dosing which is more accurate and eliminates prescription errors which occur in the known dosing systems. The method of the present invention is adapted for use in various healthcare facilities such as, but not limited to, hospitals, surgeries, nursing homes, clinics and pharmacies.

More particularly, the present: invention provides interactive cross-checking of drug regimes for individual patients prior to admission. The present invention also provides an automated interactive system for detecting prescription error, either at a point of sale (such as a pharmacy) or at hospitals, clinics, or health care at home.

The present invention eliminates or at least minimises the problems associated with dose errors (i.e. individualised patient doses for his/her case) for prescribed drugs which can be caused by the doctor, pharmacist, nurse or other prescriber or administrator. The use of a computer system allows the construction of a database of allowable ranges and dosages to enable checking by health practitioners on patient data and the medication which can help health professionals (HP) make their decision on the accuracy of the drugs prescribed.

The present invention further provides a computer program which enables comparative analysis between a prescribed drug dosing regime and a reference drug regime for the profile of a particular patient. The present invention further provides a method of drug dosing which is more accurate and eliminates prescription errors which occur in the known administration systems. The present invention provides an alternative to the known dosing methods and regimes to enable practitioners to deliver potentially error free drug delivery and administration.

It is one object of the present invention to increase the efficiency of drug prescription and administration by reducing reliance on manual checking steps.

In its broadest form the present invention comprises:

a computer application adapted for establishing accuracy of prescription and administration of drugs to drug recipients, the application comprising a database of dosage regimes and limits for a variety of classes of drug recipients; wherein the database provides reference parameters for comparing a prescribed drug or drug dosing regime with predetermined drugs or drug administration regimes to determine it the prescribed drug or drug dosing regime is within prescribed safe limits for a particular recipient compared to a class of like recipient selected from the database.

In another broad for m the present invention comprises; a method of administration of a drug or drug regime to a potentially unlimited number of drug recipients, the method comprising the steps of

a) providing a prescription for at least one drug in a drug dosing regime to a drug recipient,
b) prior to administration of the at least one drug, inputting drug parameters and drug recipient profile particulars for a particular drug recipient into a computer program
c) allowing the program to compare the prescription parameters and determine if the parameters fall within predetermined safety limits thereby avoiding over-doses or under-doses of prescribed drug dosages.

According to one embodiment the administration regime comprises dosages of a particular concentration administered over a predetermined period. According to a preferred embodiment, the parameters for a particular drug recipient include drug type, dosage, duration of medication, time space between dosages, patient age, sex, medical condition, disease, genetic makeup, maximum safe dosages. The computer program may be presented as a downloadable app or proprietary program for integration into computer networks accessible to health practitioners at the prescription end, dispensing stage and administration end.

In another broad form the present invention comprises:

a downloadable computer application adapted for use in prescription, dispensing and administration of drugs to drug recipients, the application comprising a database of drug dosage regimes and limits for a variety of drug recipients; wherein the database provides a reference for comparing a prescribed drug's dose or drug administration regime with an acceptable safe drug's dose or drug administration regime for a particular drug recipient to determine if the prescribed drug's dose or drug administration regime is within prescribed safe limits for the particular recipient,

The application allows a practitioner to input drug recipient data to enable the program to ascertain if what is prescribed is within safe, recommended or allowable limits. A practitioner or any person wishing to ascertain if what is prescribed is accurate and safe can, if there is doubt about the accuracy of prescribed drugs, use the app to establish safety and compliance with acceptable ranges.

in a case where operating software is being used, the process begins with entry of prescription data for a particular drug recipient. Minimum data that can be entered is the drug, the prescribed dose, patient age, sex and existing medical condition. According to an alternative embodiment, the reference database is located remote from the practitioner conducting the error check. This may be accessed on-line or via icloud technology or other cyber storage facility. According to an alternative embodiment, the data reference station is centralised and receives uploaded data relating to drug prescription material and after checking the prescription data, the station provides a clearance that the prescribed material is error free.

According to one embodiment the error checking is conducted using a local computer preloaded with error checking software, mobile phone having an application for processing data for error checking, an ipad or mobile tablet or other device. Input to the communication devices which interact with the error checking software is manual or scanned including photo scanning or voice.

In another broad form the present invention comprises:

a method of checking prescription data for dosing errors using a computer application enabling automated drug data collection and error checking; the method comprising the following steps;
a) providing a software program incorporated in and operable by an electronic device;
b) collecting data collected at a patient location related to a patient drug regime;
c) entering/inputting said data into a newly established or existing database of patient data via in the electronic device for a potentially unlimited number of patients;
d) uploading the parameters of a drug prescription regime;
e) allowing the software in the computer application to check the drug regime against recommended dose ranges retained in the application,

In another broad form of a method aspect the present invention comprises: a method for error checking of drug prescription data, the method comprising the steps of:

a) providing a portable electronic device for use by a health service provider to read, store and process drug related data;
b) providing a patient identity and uploading patient data into software in said electronic device;
c) uploading drug prescription data to the electronic device;
d) checking uploaded data against reference data pre-loaded in said electronic device to determine existence of errors in said drug administration data.

In another broad form the present invention comprises:

an assembly for collecting data related to a prescribed drug regime; the assembly comprising; a data input device capable of receiving, processing and storing data related to a patient parameters, drug prescription and administration regime;

means associated with the data input device to receive said prescription regime data;

means at the data receiving station to process receive, store and verify accuracy of data particulars and parameters;

means at the data input device to compare data input with a reference data in the software to ascertain if errors are present in the prescribed drug regime.

The present invention eliminates the prior art systems which are error prone and use manual steps for drug prescription checking. The portable data collection system is user friendly and convenient for a practitioner, eliminates duplication of inputs and allows retention of patient data for future use. It will be appreciated by persons skilled in the art that the system and enabling; apparatus and software is adaptable to the regulatory framework and legislation for a particular jurisdiction.

In another broad form according to an apparatus aspect, the present invention comprises;

a computer software application for use in medical prescription and administration of patient drugs, the application capable of receiving, storing, processing, altering, updating, amending data input regarding patient drug dosages and particulars, wherein the application allows a user to input data into an application preloaded into an electronic device such as a phone, ipad, computer, television or tablet; the application allowing data to be uploaded, to a first processing station for data processing including data verification and checking. It is one object of the present invention to avoid errors including human error, typographical errors, database errors.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which, the invention may be practiced. These embodiments will be described in sufficient detail to enable those skilled in the art to practice the invention, and it is to be understood that other embodiments may be utilised and that structural changes may be made without departing from the scope of the invention. The following detailed description is, therefore, not to be taken in a limiting sense, and the scope of the present invention is best defined by the appended claims.

### DETAILED DESCRIPTION

The present invention will now be described in more detail according to a preferred but non limiting embodiment and with reference to the accompanying schematic illustrations, wherein;

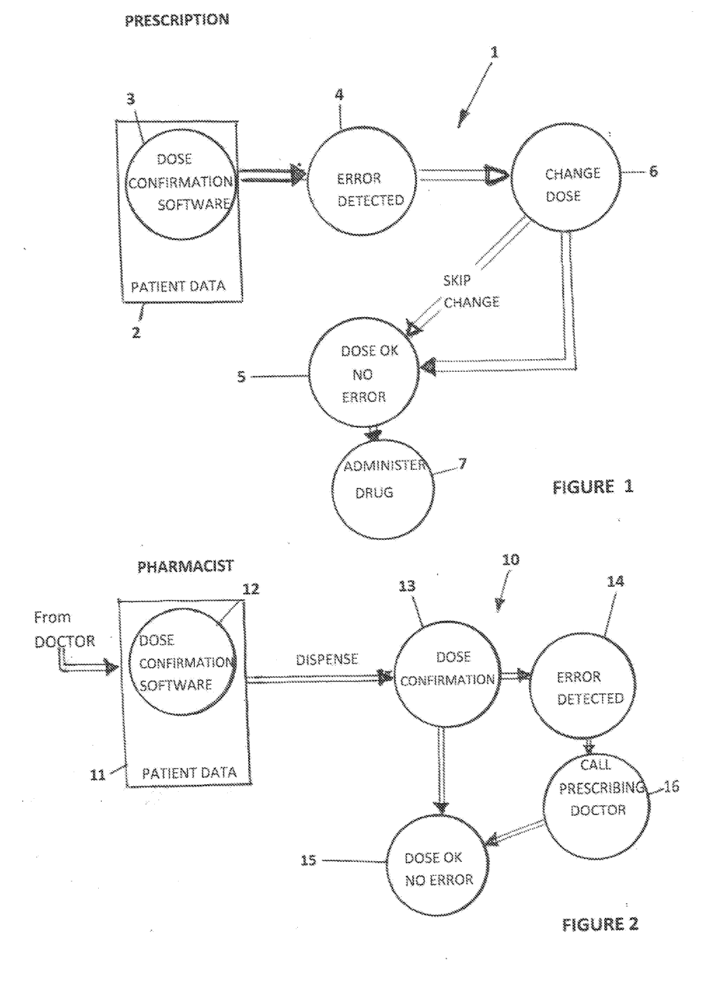

FIG. 1 shows a schematic layout of a dosing error detecting system according to one embodiment at the prescription stage.

FIG. 2 shows a schematic layout of a dosing error detecting system according to an alternative embodiment at the dispensing stage.

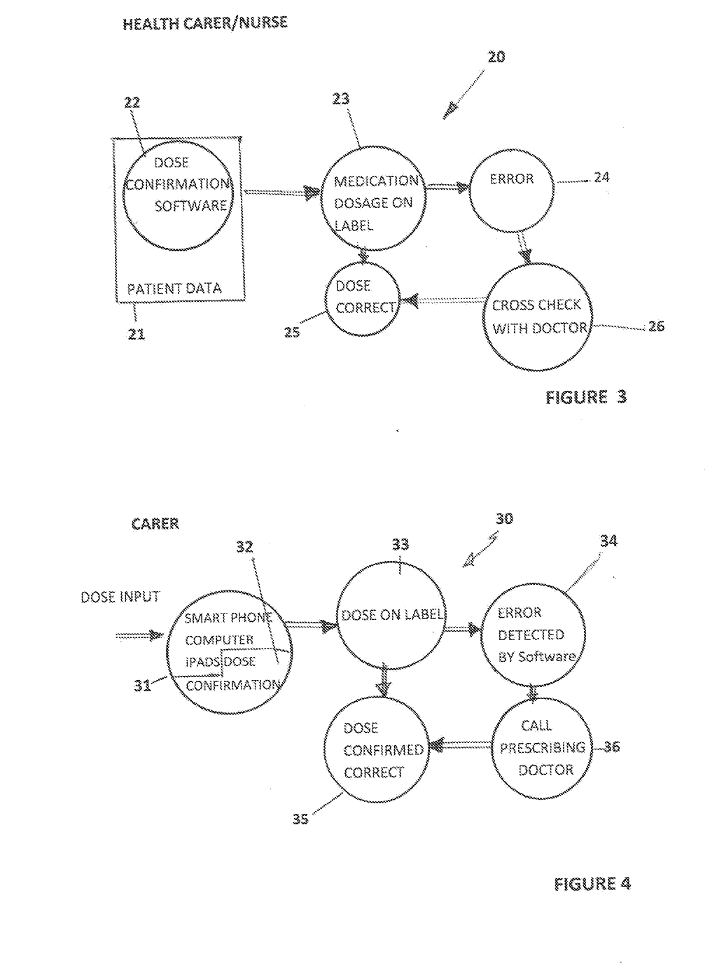

FIG. 3 shows a schematic layout of a dosing error detecting system according to an alternative embodiment at the career administration stage.

FIG. 4 shows a schematic layout of a dosing error detecting system according to an alternative embodiment used in a private home or the like.

The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description. Although the method and apparatus aspects of the invention will be described with reference to their application to medical consultation billing it will be appreciated that the invention has alternative applications. A reference to a computer can be taken to include a reference to a mobile phone, iphone, tablet, ipad, icloud or other means for holding a data base.

Referring to FIG. 1 there is shown a schematic layout 1 of a dosing error detecting system according to one embodiment at the prescription stage. A medical practitioner prepares a prescription and sets out the dosage of one or more drugs on the prescription. The required dosages are normally set by the prescribing doctor. At station 2 the prescribing doctor typically inserts patient parameters into a computer program (age, weight, BMl, ClC, liver function & others). Associated with that program is an integrated program or a standalone program 3 (dose confirmation software) which receives dosage data from the prescriber relating to drugs prescribed to a particular patient. An error will be detected indicated by station 4 or the dosage will initially be determined as correct indicated by station 5. If an error is detected, the software will alert the practitioner to change the dose indicated by station 6 and suggest recommended dosage range. Once the correct dose is verified the prescription can be forwarded for dispensing indicated by station 7 skip it

FIG. 2 shows a schematic layout of a dosing error detecting system according to an alternative embodiment at the dispensing stage. Referring to FIG. 2 there is shown a schematic layout 10 of a dosing error detecting system according to an alternative embodiment at the pharmacist stage. A pharmacist dispenses a prescription and checks the dosage of one or more drugs on the prescription. The required dosages are normally set by the prescribing doctor. At station 11 the prescribing pharmacist or doctor typically inserts patient parameters into a computer program held in an electronic device Associated with that program is an integrated program or a standalone program 12 (dose confirmation software) which receives dosage data from the prescriber relating to drugs prescribed to a particular patient. After dose confirmation at station 13 there will be confirmation of an error 14 or no error 15 in the prescribed dosages. Where an error is detected, the pharmacist calls the prescribing doctor (station 16) to correct the dosage or suggest recommended dose or abandonment of the original prescription.

FIG. 3 shows a schematic layout of a dosing error detecting system 20 according to an alternative embodiment at the carer administration stage. At station 21 the carer who may be a health career or nurse practitioner typically inserts patient parameters into a computer program. Associated with that program is an integrated program or a standalone program 22 (dose confirmation software) which receives dosage data from the prescriber relating to drugs prescribed to a particular patient. A carer checks a drug label at station 23 for medication dosage and checks the dosage of one or more drugs normally set by the prescribing doctor and labeled by the pharmacist After dose confirmation at station 23 there will be confirmation of an error 24 or no error—station 25 in the prescribed dosages. Where an error is detected, the carer calls the prescribing doctor or pharmacist (station 26) to correct the dosage. Dosing error checking can then be repeated.

FIG. 4 shows a schematic layout of a dosing error detecting system 30 according to an alternative embodiment used in a private home or the like. A user who may be a carer checks a drug label at station 31 and checks the dosage of one or more drugs normally set by the prescribing doctor and labeled by the pharmacist. At station 31 the user using, an app, associated with a computer, ipad, iphone, android or computer typically inserts patient parameters into the app or computer program. Dose confirmation software 32 receives dosage data from the user relating to drugs prescribed to or for the user. After dose confirmation at station 33 there will be confirmation of an error 34 or no error 35 in the prescribed dosages. Where an error is detected, the user can inform the pharmacist and/or the prescribing doctor (station 36) to obtain the correct the dosage. Dosing error checking can then be repeated

The dose confirmation software contains all medications and dosages, strengths, duration of dosages of particular drugs, active ingredients, generics and identifying bar codes where applicable. The prescribed drugs and drug dosages are usually related to relationships with age, gender, weight of the patient. It also has other relevant data such as body mass index and suitability of drug and dose for particular patient parameters. The user can select one or more from the aforesaid parameters to activate the comparisons The information in the data base is intended to ensure suitability for a particular class of patient and ultimately to ensure no prescription error is allowed to reach the patient, The software also includes facility to calculate dose at any previous stage not matching stored data. The software app confirms dose inputted or suggests an alternative does if an error or other anomaly is detected with the initial input data. Recommendations can be skipped. Updates are available for cross checking doses in case for instance where dosage regimes might be updated.

According to a preferred embodiment the system is integrated with an application (computer app) which facilitates expedient establishment of records, recall of existing records and processing of cross checking, According to a preferred embodiment the method incorporates a computer program, computer application or the like which holds data which provides a reference for comparison of prescription or drug administration data. The data base of said data is compiled from data sources such as pharmacological medical, nursing and like data to allow cross checking between prescription data and acceptable ranges and parameters for administration to the patient for whom medicine has been prescribed. The user can select one reference to check against the data base.

In practice a health practitioner prescribes medication for a particular recipient who may for example be a hospital patient, nursing home resident or pharmacist customer Errors can occur at the prescribing practitioner end, at the supplier (pharmacist) and at the administration end—hospital nursing home etc. Although checking takes place at each stage, errors do occur and this can be passed down the line sometimes unchecked if it occurs at the prescriber end. Users of the application according to the present invention are such persons as pharmacists, nurses, doctors and others in pharmacies, hospitals, clinics, nursing homes whose role is to administer drugs.

According to one embodiment the program incorporates combined data from a number of reference sources or a data set from a single source. The sources of data may be from national or international data bases relating to pharmacological prescription administration and safety including dosage regimes.

According to one embodiment the application comprises from a program with a data bank from references based on pharmaceutical and medical programs combined to existing prescription software. Alternatively, the application comprises standalone software which is used by the health provider. The software will use references from national and international sources. The software can be integrated to existing prescription software by health professionals and compared with updated data in references and guidelines. Dose calculation can be checked to alert health professionals to errors and to enable administration of the correct dose depending on the age of the patient, weight, liver function, renal function . . . etc.

One advantage of the present invention is that the software has been created to check the dose calculation of a liquid dosage regarding certain parameters which differ from one patient to another to tailor the dose for each patient, if there is any change in the dose the software will alert the user. Current regimes for error checking do not distinguish between age, weight, liver and renal functions of the patients. This software takes into account the parameters that could interact with the dose to allow adjustment to within the safety margins.

Preferably in addition to the primary function of the software in error checking, it also provides facility for links to medical and pharmaceutical references and updates, a user manual, renewal licenses, multilingual versions, troubleshooting section. Each feature has a description for the user including its functionality. The software program can be integrated into any existing dispensing program. It includes features such as correct dose suggestions when dosage calculation errors are detected. The software also includes facility to adjust dosages for patients with critical illnesses such as but not limited to (dysfunction) such as renal failure, hepatic disease, auto immune disease. The software according to one embodiment is integrated into the user's desktop computer or can be easily integrated into any existing drug processing program. The software includes updates of changes in drug dose and administration recommendations and can be adapted to any foreign language. Content includes diagrams, figures, experimental data, flow-charts, which may be helpful in describing your invention.

A consumer obtains an app which includes data such as, but not limited to, billing coding, medical benefits schedule of fees and integrated listing of health funds. An initial screen invites a user to enter new data related to a patient drug regime and patient parameters. if a prescription for a patient whose prescription has been checked previously the patient data is recognized and requires no additional input. If a patient is already established in the data base a display screen will invite input of the patient identity and show the patient profile including past drug, date of the previous prescription check and other data such as the referring doctor.

An advantage of the present invention is that a medical practitioner or other health care provider can minimise errors or omissions and increase their remuneration through better efficiency and reduced errors. A further advantage is that the costs of processing are minimised due to reduced errors. A further advantage is that it reduces errors which currently cost the health budget millions each year as the electronic apparatus allows error checking at all stages of drug prescription and administration.

The practitioner can input data into the electronic device by manual input or scanning data. Once the data is in the electronic data storage device, the data is delivered directly to an online provider which can check the data for errors.

The present invention allows the doctors, pharmacists, nurses and other health professionals to access the reference data base and as required to upload prescription data for cross checking. The present invention streamlines and fully integrates prescription data error checking process that is critical to the operation of drug, administration.

A major advantage is the time saving involved in error checking and the ease of access to checking software via modem hand held devices. The risk of the effects from making errors are minimised so that the practitioner is less likely to incur liability and the patient or drug user avoids the unwanted effects of prescription errors.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of administration of a drug or drug regime to a potentially unlimited number of drug recipients, the method comprising the steps of
a) providing a prescription for at least one drug in a drug dosing regime to a drug recipient,
b) prior to administration of the at least one drug, inputting drug parameters and drug recipient profile particulars for a particular drug recipient into a computer program
c) allowing the program to compare the prescription parameters to a set of safety parameters to determine if the parameters fall within predetermined safety limits thereby avoiding over-doses or under-doses of prescribed drug dosages.

2. A method according to claim 2 wherein the drug administration regime comprises the additional step of providing dosages of a particular concentration administered over a predetermined period.

3. A method according to claim 2 wherein the parameters for a particular drug recipient include drug type, dosage, duration of medication, time space between dosages, patient age, sex, medical condition, disease, genetic makeup and maximum safe dosages.

4. A method according to claim 3 comprising the further step of downloading a computer application program.

5. A method according to claim 4 wherein a user uses the computer application to verifies accuracy of said prescription data for a patient relative to profile parameters of a prescription recipient in the same or a similar class to the patient.

6. A method according to claim 5 wherein comprising the further step of changing a dose or drug type in the event of an error detection by the accuracy verification step.

7. A method for error checking of drug prescription data, the method comprising the steps of
a) providing a portable electronic device for use by a health service provider to read, store and process drug related data;
b) providing a patient identity and uploading patient data into software in said electronic device:
c) uploading drug prescription data to the electronic device for a particular patient;
d) checking uploaded drug prescription data against reference data pre-loaded in said electronic device to determine existence of errors in said drug administration data.

8. A method according to claim 7 including the step prior to checking uploaded prescription data of selecting reference data according to predetermined patient profile parameters.

9. A method according to claim 8 wherein the patient profile parameters include parameters selected from patient age, sex, medical condition, patient medical characteristics, patient symptoms, drug interactions, allergies, side effects, patient dosages.

10. A computer application adapted for establishing accuracy of prescription and administration of drugs to drug recipients, the application comprising a database of dosage regimes and limits for a variety of classes of drug recipients; wherein the database provides reference parameters for comparing a prescribed drug or drug dosing regime with predetermined drugs or drug administration regimes to determine if the prescribed drug or drug dosing regime is within prescribed safe limits for a particular recipient compared to a class of like recipient selected from the database.

11. A computer application according to claim 10 wherein the computer program may be presented as a downloadable app or proprietary program for integration into computer networks accessible to health practitioners at the prescription end, dispensing stage and administration end.

12. A computer application according to claim 11 wherein the computer program which enables comparative analysis between a prescribed drug dosing regime and a reference thug regime for the profile of a particular patient once patient profile parameters have been inserted into the program.

13. A computer application according to claim 12 wherein prescription error checking is conducted using a local computer preloaded with error checking software.

14. A computer application according to claim 13 wherein data input to the communication devices which is compared to error checking software is scanned including photo scanning or voice scanning.

15. A computer application according to claim 13 wherein, the application is retained in an electronic device selected from a mobile phone, an ipad, icloud, mobile tablet or other portable electronic device capable of retaining and processing data for error checking.

16. A downloadable computer application adapted for use in error checking in prescription, dispensing and administration of drugs to drug recipients, the application comprising a, database of drug dosage regimes and limits for a variety of drug recipients; wherein the database provides a reference for comparing a prescribed diva's dose or drug administration regime with an acceptable safe drug's dose or drug administration regime for a particular drug recipient to determine if the prescribed drug's dose or drug administration regime is within prescribed safe limits for the particular recipient.

17. A computer application according to claim 16 wherein the data includes safety ranges which enable comparison to prescribed drug dosage.

18. A computer application according to claim 17 wherein the reference database of drug dosage regimes is accessible via a centralised remote station which receives uploaded data relating to drug prescription.

19. A computer application according to claim 18 wherein, the reference database is located remote from a practitioner conducting the error check.

20. A computer application according to claim 19 wherein the data base is e accessible on-liner via icloud technology or other cyber storage facility.

21. A method of checking prescription data for dosing errors using a computer application enabling automated drug data collection and error checking; the method comprising the following steps;
a) providing a software program incorporated in and operable by an electronic device;
b) collecting data collected at a patient location related to a patient drug regime;
c) entering/inputting said data into a newly established or existing database of patient data via in the electronic device for a potentially unlimited number of patients;
d) uploading the parameters of a drug prescription regime;
e) allowing the software in the computer application to check the drug regime against recommended dose ranges retained in the application.
